(19) United States
(12) Patent Application Publication
(10) Pub. No.: US 2004/0184696 A1
(43) Pub. Date: Sep. 23, 2004

(54) Integrated variable optical power splitter

(76) Inventors: Cheng-Hsi Miao, San Jose, CA (US); Ying-Moh Liu, Saratoga, CA (US)

Correspondence Address: Billy Lau, 486 Vista Del Norte, Walnut, CA, 91789-1605, US

(21) Appl. No.: 10/391,695

(22) Filed: Mar. 18, 2003

(51) Int. Cl. G02B 6/26

(52) U.S. Cl. 385/11; 385/48

(57) ABSTRACT

This invention relates to a variable optical power splitter with an integrated variable optical attenuator. According to an embodiment of this invention, a first polarizing beam splitter separates an incident light beam into two substantially mutually orthogonally polarized light beams. Rotator cells are arranged to change the polarization directions of the polarized light beams to control the power splitting ratio between a first output and a second output. A second polarizing beam splitter diverts a first and a second predetermined polarization components in the polarized light beams to the first and the second outputs respectively. At each output, there are rotator cells and a polarizing beam splitter. These rotator cells changes the polarization directions of the diverted light beams to control the attenuations to the diverted light beams. The polarizing beam splitter combines predetermined polarization components of the diverted light beams into a single light beam at the output.

### FIELD OF THE INVENTION

This invention generally relates to optical components. Particularly, this invention relates to a variable optical power splitter with an integrated variable optical attenuator.

### BACKGROUND OF THE INVENTION

Variable optical power splitters and variable optical attenuators are widely employed in optical networks. A variable optical power splitter can be operated as a 1×2 optical switch. In many applications, variable optical attenuators are connected directly to variable optical power splitters. A representative application is the equalization of the optical power levels in the branches of a variable optical power splitter that is operated as an optical switch. There is a variable optical attenuator on each branch of the variable optical power splitter. One skilled in the art readily understands that there are other applications besides optical networks. Currently, most variable optical power splitters and variable optical attenuators are in separate packages. Optical fibers are used to connect the packages. This combination of optical power splitters and variable optical attenuators requires more space and costs more than necessary. It is therefore an object of this invention to provide a variable optical power splitter with integrated variable optical attenuators.

### DESCRIPTION OF THE DRAWINGS

A better understanding of the invention may be gained from the consideration of the following detailed description taken in conjunction with the accompanying drawings in which:

FIG. 1 shows the configuration of an embodiment of the present invention.

### DETAILED DESCRIPTION OF THE INVENTION

In the description that follows, like parts are indicated throughout the specification and drawings with the same reference numerals. The present invention is not limited to the specific embodiments illustrated herein.

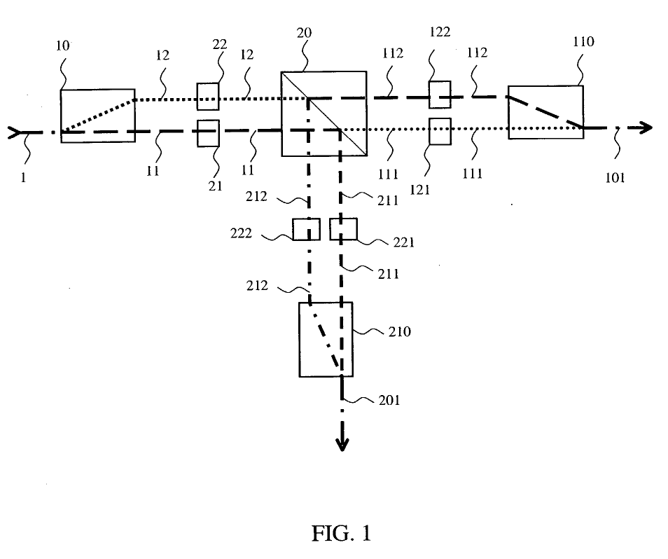

FIG. 1 shows the configuration of an embodiment according to this invention. Referring to FIG. 1, polarizing beam displacer 10 separates input light beam 1 from the input to first light beam 11 and second light beam 12. When they exit from polarizing beam displacer 10, first light beam 11 is P-polarized and second light beam 12 is S-polarized both with respect to polarizing beam displacer 10. A polarizing beam displacer is a special polarizing beam splitter that outputs two parallel polarized light beams. In contrast, a generic polarizing beam splitter outputs two polarized light beams that are at an angle with respect to each other. According to this invention, a generic polarizing beam splitter can be used instead of a polarizing beam displacer. Nevertheless, the optical arrangement for using a generic polarizing beam splitter instead of a polarizing beam displacer may be more complex. One skilled in the art readily understands that the polarizations of the P-polarized and S-polarized light beams from a physical polarizing beam splitter, including a physical polarizing beam displacer, are substantially mutually orthogonal, and the P-polarized and S-polarized light beams from a physical polarizing beam displacer are substantially parallel. Further, one skilled in the art may refer to the polarization state of a light beam as the polarization of the light beam.

Polarizing beam-splitting system 20 separates the first light beam 11 into a third light beam 111 containing a first polarization component of the first light beam 11 and a fourth light beam 211 containing a second polarization component of the first light beam 11, and separates the second light beam 12 into a fifth light beam 112 containing the first polarization component of the second light beam 12 and a sixth light beam 212 containing the second polarization component of the second light beam 12. Further polarizing beam-splitting system 20 diverts the third light beam 111 and the fifth light beam 112 to the first output, and diverts the fourth light beam 211 and the sixth light beam 212 to the second output. The polarization directions of the first polarization component of the polarizing beam-splitting system 20 and the second polarization component of the polarizing beam-splitting system 20 are orthogonal.

In the light path of first light beam 11 between first polarizing beam displacer 10 and polarizing beam-splitting system 20, first liquid crystal cell 21 alters the polarization of first light beam 11 at polarizing beam-splitting system 20 in response to a first signal. In the light path of second light beam 12 between first polarizing beam displacer 10 and polarizing beam-splitting system 20, second liquid crystal cell 22 alters the polarization of second light beam 12 at polarizing beam-splitting system 20 in response to a second signal.

Second polarizing beam displacer 110 recombines the P-polarization component of third light beam 111 and the S-polarization component of fifth light 112 beam into the first output light beam 101 at the first output; in which the P-polarization and S-polarization are defined by second polarizing beam displacer 110. Third polarizing beam displacer 210 recombines the P-polarization component of fourth light beam 211 and the S-polarization polarization component of the sixth light beam 212 into the second output light beam 201; in which the P-polarization and S-polarization are defined by third polarizing beam displacer 210. One skilled in the art readily understands that a physical polarizing beam splitter, including a physical polarizing beam displacer, can be employed to substantially recombine the P-polarized component of a first light beam and the S-polarized component of a second light beam.

In the light path of third light beam 111 between polarizing beam-splitting system 20 and second polarizing beam displacer 110, third liquid crystal cell 121 alters the polarization of third light beam 111 at second polarizing beam displacer 110 in response to a third signal. In the light path of fourth light beam 211 between polarizing beam-splitting system 20 and third polarizing beam displacer 210, fourth liquid crystal cell 221 alters the polarization of fourth light beam 211 at third polarizing beam displacer 210 in response to a fourth signal. In the light path of fifth light beam 112 between polarizing beam-splitting system 20 and second polarizing beam displacer 110, fifth liquid crystal cell 122 alters the polarization of fifth light beam 112 at second polarizing beam displacer 110 in response to a fifth signal. In the light path of sixth light beam 212 between polarizing beam-splitting system 20 and third polarizing beam displacer 210, sixth liquid crystal cell 222 alters the polarization of sixth beam 212 at third polarizing beam displacer 210 in response to a sixth signal.

In operation, changing the first and second signals applied to first liquid crystal cell 21 and second liquid crystal cell 22 respectively changes the optical power splitting between first output and second output. Changing the third and fifth signals applied to third liquid crystal cell 121 and fifth liquid crystal cell 122 respectively changes the attenuation at the first output. Changing the fourth and sixth signals applied to fourth liquid crystal cell 221 and sixth liquid crystal cell 222 respectively changes the attenuation at the second output. Further, changing the signals changes the polarization components at outputs. To divert all the optical power to first output, change the first signal and the second signal so that first light beam 11 and second light beam 12 are P-polarized with respect to polarizing beam-splitting system 20 at polarizing beam-splitting system 20. Alternatively, to divert all the optical power to second output, change the first signal and the second signal so that first light beam 11 and second light beam 12 are S-polarized with respect to polarizing beam-splitting system 20 at polarizing beam-splitting system 20. For minimum attenuation at first output, change the third signal and the fifth signal so that that third light beam 111 is P-polarized and the fifth light beam 112 is S-polarized with respect to second polarizing beam displacer 110. Similarly, for minimum attenuation at second output, change the fourth signal and the sixth signal so that that fourth light beam 211 is P-polarized and the sixth light beam 212 is S-polarized with respect to third polarizing beam displacer 210. Alternatively, for maximum attenuation at first output, change the third signal and the fifth signal so that that third light beam 111 is S-polarized and the fifth light beam 112 is P-polarized with respect to second polarizing beam displacer 110. Similarly, for maximum attenuation at second output, change the fourth signal and the sixth signal so that that fourth light beam 211 is S-polarized and the sixth light beam 212 is P-polarized with respect to third polarizing beam displacer 210.

There are numerous variations to the embodiments above that may be trivial to the ones skilled in the art. Examples of these variations include but not limited to:

add temperature control to the liquid crystal cells to improve speed and stability;

polarizing beam-splitting system 20 may include a single polarizing beam splitter or multiple polarizing beam splitters;

change the orientation of the beam splitter and/or beam displacers, change the optical arrangement and the signals applied to the liquid crystal cells accordingly; for example, rotate the beam displacer by one hundred and eighty degrees;

varying the signals applied to the liquid crystal cells can control the polarization of the output light beams;

use either a magneto-optic cell or any other polarization rotator cell that is controllable by an external signal instead of a liquid crystal cell; and

the magneto-optic cell or liquid crystal cell may be constructed and arranged to alter the polarization of the light reflected from it instead of passing through it as show in the figures, and the optical arrangement will be changed accordingly.

Although the embodiment of the invention has been illustrated and that the form has been described, it is readily apparent to those skilled in the art that various modifications may be made therein without departing from the spirit of the invention.

What is claimed is:

1. An integrated variable optical power splitter for distributing an input light beam at a first output and a second output, comprising:
a first polarizing beam splitter being disposed to substantially separate said input light beam into a first polarized light beam and a second polarized light beam;
a first optical polarization rotator cell responsive to a first signal being disposed to alter the polarization of said first polarized light beam in to a first altered polarized light beam;
a second optical polarization rotator cell responsive to a second signal being disposed to alter the polarization of said second polarized light beam in to a second altered polarized light beam;
a polarizing beam splitter system being disposed to substantially separate a first predetermined polarization component of said first altered polarized light beam into a third polarized light beam, a second predetermined polarization component of said first altered polarized light beam into a fourth polarized light beam, a first predetermined polarization component of said second altered polarized light beam into a fifth polarized light beam, and a second predetermined polarization component of said second altered polarized light beam into a sixth polarized light beam;
a third optical polarization rotator cell responsive to a third signal being disposed to alter the polarization of said third polarized light beam in to a third altered polarized light beam;
a fourth optical polarization rotator cell responsive to a fourth signal being disposed to alter the polarization of said fourth polarized light beam in to a fourth altered polarized light beam;
a fifth optical polarization rotator cell responsive to a fifth signal being disposed to alter the polarization of said fifth polarized light beam in to a fifth altered polarized light beam;
a sixth optical polarization rotator cell responsive to a sixth signal being disposed to alter the polarization of said sixth polarized light beam in to a sixth altered polarized light beam;
a second polarizing beam splitter being disposed to substantially recombine a third predetermined polarization component of said third altered polarized light beam and a fifth predetermined polarization component of said fifth altered polarized light beam into a light beam at said first output; and
a third polarizing beam splitter being disposed to substantially recombine a fourth predetermined polarization component of said fourth altered polarized light beam and a sixth predetermined polarization component of said sixth altered polarized light beam into a light beam at said second output.

2. The integrated variable optical power splitter as claimed in claim 1, wherein,
the polarizations of said first polarized light beam and said second polarized light beam are substantially mutually orthogonal;
said first predetermined polarization component and said second predetermined polarization component are mutually orthogonal;
said third predetermined polarization component and said fifth predetermined polarization component are mutually orthogonal; and
said fourth predetermined polarization component and said sixth predetermined polarization component are mutually orthogonal.

3. The integrated variable optical power splitter as claimed in claim 1, further comprising:
a temperature control system for controlling the temperature of said integrated variable optical power splitter.

4. The integrated variable optical power splitter as claimed in claim 1, wherein, said optical polarization rotator cells comprise at least one transmissive liquid crystal cell being responsive to an external signal for rotating the polarization of transmitted light.

5. The integrated variable optical power splitter as claimed in claim 1, wherein, said optical polarization rotator cells comprise at least one reflective liquid crystal cell being responsive to an external signal for rotating the polarization of reflected light.

6. The integrated variable optical power splitter as claimed in claim 1, wherein, said optical polarization rotator cell comprises at least one transmissive magneto-optic cell being responsive to an external signal for rotating the polarization of transmitted light.

7. The integrated variable optical power splitter as claimed in claim 1, wherein, said optical polarization rotator cell comprise at least one reflective magneto-optic cell being responsive to an external signal for rotating the polarization of reflected light.

8. The integrated variable optical power splitter as claimed in claim 1, wherein, said polarizing beam splitter system comprises a polarizing beam splitter.

9. The integrated variable optical power splitter as claimed in claim 1, wherein, said polarizing beam splitters comprise at least one polarizing beam displacer.

10. The integrated variable optical power splitter as claimed in claim 1, wherein, said integrated variable optical power splitter is operated to divert the optical power from said input light beam to one selected from said first output and said second output.

11. The integrated variable optical power splitter as claimed in claim 1, wherein, said integrated variable optical power splitter is operated to distribute the optical power from said input light beam to said first output and said second output.

12. The integrated variable optical power splitter as claimed in claim 1, wherein, said integrated variable optical power splitter is operated so that the optical power in said input light beam is larger than the total optical power in the light beams at said first output and said second output.

13. The integrated variable optical power splitter as claimed in claim 1, wherein, said integrated variable optical power splitter is operated so that the polarization of the light beam at said first output is different from the polarization of said input light beam.

14. The integrated variable optical power splitter as claimed in claim 1, wherein, said integrated variable optical power splitter is operated so that the polarization of the light beam at said second output is different from the polarization of said input light beam.

15. The integrated variable optical power splitter as claimed in claim 1, wherein, said optical polarization rotator cells comprise transmissive liquid crystal cells being responsive to an external signal for rotating the polarization of transmitted light.

16. The integrated variable optical power splitter as claimed in claim 15, wherein, said polarizing beam splitter system comprises a polarizing beam splitter.

17. The integrated variable optical power splitter as claimed in claim 16, wherein, said polarizing beam splitters comprise polarizing beam displacers.

18. The integrated variable optical power splitter as claimed in claim 16 further comprises a temperature control system.

19. The integrated variable optical power splitter as claimed in claim 1, wherein, said integrated variable optical power splitter is operated to divert the optical power from said input light beam to one selected from said first output and said second output.

20. The integrated variable optical power splitter as claimed in claim 1, wherein, said integrated variable optical power splitter is operated to distribute the optical power from said input light beam to said first output and said second output.

21. The integrated variable optical power splitter as claimed in claim 1, wherein, said integrated variable optical power splitter is operated so that the optical power in said input light beam is larger than the sum of the optical power in said light beam at said first output and the optical power in said light beam at said second output.

22. The integrated variable optical power splitter as claimed in claim 1, wherein, said integrated variable optical power splitter is operated so that the polarization of the light beam at said first output is different from the polarization of said input light beam.

23. The integrated variable optical power splitter as claimed in claim 1, wherein, said integrated variable optical power splitter is operated so that the polarization of the light beam at said second output is different from the polarization of said input light beam.
